(19) United States
(12) Patent Application Publication
(10) Pub. No.: US 2003/0093465 A1
(43) Pub. Date: May 15, 2003

(54) Management strategies for internationalization in a distributed computer environment

(75) Inventors: Debasish Banerjee, Rochester, MN (US); Jeffrey Alan Frey, New Paltz, NY (US); Robert Howard High JR., Round Rock, TX (US); Ute Schuerfeld, Wappingers Falls, NY (US); David Alan Zavala, Rochester, MN (US)

Correspondence Address: Gero G. McClellan, Moser, Patterson & Sheridan, L.L.P., Suite 1500, 3040 Post Oak Boulevard, Houston, TX, 77056-6582, US

(73) Assignee: INTERNATIONAL BUSINESS MACHINES CORPORATION, ARMONK, NY

(21) Appl. No.: 10/000,686

(22) Filed: Oct. 31, 2001

(51) Int. Cl. G06F 15/16

(52) U.S. Cl. 709/203; 709/225

(57) ABSTRACT

A method and system for managing client locale information to a server in a distributed computer enterprise. When a client generates a request to a remote server, the client's international context (e.g., locale and time zone information) is associated with the request. The server then retrieves an internationalization management policy and processes requests from the client according to the internationalization context that is configured by the internationalization context management policy. The internationalization context is propagated to successive servers that further service the client's request.

### BACKGROUND OF THE INVENTION

1. Field of the Invention

The present invention relates to a distributed computer enterprise and more particularly to a system and method for managing locale and time zone sensitive operations within the distributed computer enterprise.

2. Description of the Related Art

Large organizations now desire to place all of their computing resources on a computer network. To this end, it is known to connect computers in a large, geographically dispersed network environment and to manage such an environment in a distributed manner. Illustratively, one such management framework consists of a server that manages a number of nodes, each of which has a local object database that stores object data specific to the local node. Each managed node typically includes a management framework, comprising a number of management routines that is capable of a relatively large number of simultaneous network connections to remote machines. The framework manages hundreds of megabytes of local storage and can spawn many dozens of simultaneous processes to handle requests from local or remote users.

In a conventional distributed computer environment it is often assumed that a server and its clients are operating in the same locale and or time zone. This assumption no longer holds true for e-business and web applications. Managed nodes are often located across national boundaries. Thus, a typical managed network of the type described above may include offices located in numerous countries. Due to the worldwide acceptance of the Internet, a server is now more likely than ever to be physically located across a time zone. It is also likely that the client will make a request that requires using cultural formatting conventions that are different from those of the server's locale. Conventionally, when a server processes a request from a client, the server will treat the request as if it occurred in the locale of the server. Without regard to the locale of the client, the server will impose its own local conventions when generating the results from the request. The client then receives the results of the request in a format that is unfamiliar to the user.

FIG. 1 illustrates one example of the results from a conventional request made by a user/client on a server. In this example, a Spanish client 102 has invoked a locale-sensitive request on an American server 104. In the conventional distributed computer environment, the server always imposes its locale upon the client. Consequently, the Spanish client will receive results in the format and time zone of the American locale and not in the desired Spanish locale. As shown, the desired result 106 of the Spanish client 102 was dramatically different from the actual result 108 returned by the American server 104. In the actual result, the server has translated the day and month from Spanish to the English language and has also changed the day/date format to an American format. The American server changed the Spanish currency format by substituting commas for periods. And finally, the American server disregarded the accent “˜” over the “n” in the Spanish word piña. This resulted in the American server providing an incorrect sorted list.

A conventional method for solving this problem is to add an extra parameter to all locale and time zone sensitive requests sent to the server. The parameter-addition solution, though outwardly simple, is intrusive, error prone and has serious limitations in real-life enterprise environments. For already deployed distributed applications, it is not possible to change interfaces for the introduction of extra parameters without incurring substantial network management overhead. Further, some protocols/languages will not support an extra parameter. For example, structured query language (SQL) queries do not have a placeholder to accommodate locale or time zone information.

Another possible solution would be a method that associates a client's internationalization context comprising client locale and time zone information with every business method request. A business method request is any method request such as a database search, banking transaction, stock transaction, or the like processed at a server. The business method request would then be processed using the client's internationalization context. While this solution may be suitable for many J2EE (Java 2 Enterprise Edition) or CORBA (Component Object Resource Broker Architecture) implementations, some server-side components may want to exercise greater control over the internationalization context.

For certain components there is a need to execute under an internationalization context which potentially can be different from the client or caller's internationalization context. Certain database applications may want to always issue SQL queries in a fixed locale. For example, the SQL query, “SELECT cust_name FROM cust_table where cust_name <=‘N’, will not return any string starting with “Ñ” if it is executed within a Spanish locale. Although it may be possible to alter the internationalization context programmatically, this is not the most desirable approach. Any programmatic alteration of the internationalization context is considered to be a hard-wire fixed approach. If a different internationalization context is ever desired, the application component may need to be re-programmed.

Therefore, there is a need for a method and system for controlling the contents of internationalization context without requiring programmatic manipulation.

### SUMMARY OF THE INVENTION

Embodiments of the present invention generally provide an article of manufacture, method and system for processing remote client requests in a distributed computer network using the client's specified time zone and locale conventions. In one embodiment, a server computer in a distributed computing environment, having a plurality of nodes across geographically dispersed boundaries contains an internationalization process. The internationalization process, when executed by a processor of the server computer, processes requests from a client computer according to an internationalization context provided by the client and configured by an internationalization management policy.

In another embodiment, a server computer receives a first request from a remote client computer. Illustratively, the server computer then receives a second request from the client computer wherein the second request comprises an internationalization context comprising the client's preferred conventions for processing the first request. The server computer retrieves an internationalization management policy and configures the internationalization context according to the management policy. The server computer then processes the first request according to the configured internationalization context.

In still another embodiment, a server computer in a distributed computing environment receives an internationalization context from a client computer. The server then processes further requests from the client computer according to the internationalization context that is configured by an internationalization management policy.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an example of the results from a conventional method request made by a user/client on a remote server.

FIG. 2 illustrates a simplified diagram showing a large distributed computing enterprise environment.

FIG. 3A illustrates a block diagram of a system management framework.

FIG. 3B illustrates a block diagram of the elements in a computer component of the system management framework.

FIG. 4 illustrates a small implementation of the distributed computing enterprise environment.

FIG. 5 illustrates the propagation of internationalization context from a client to remote servers according to an internationalization management policy.

FIGS. 6A and 6B illustrate one embodiment of the internationalization context data structure.

FIG. 7 illustrates a flowchart of the method at the client computer.

FIG. 8 illustrates a flowchart of the method at the server computer.

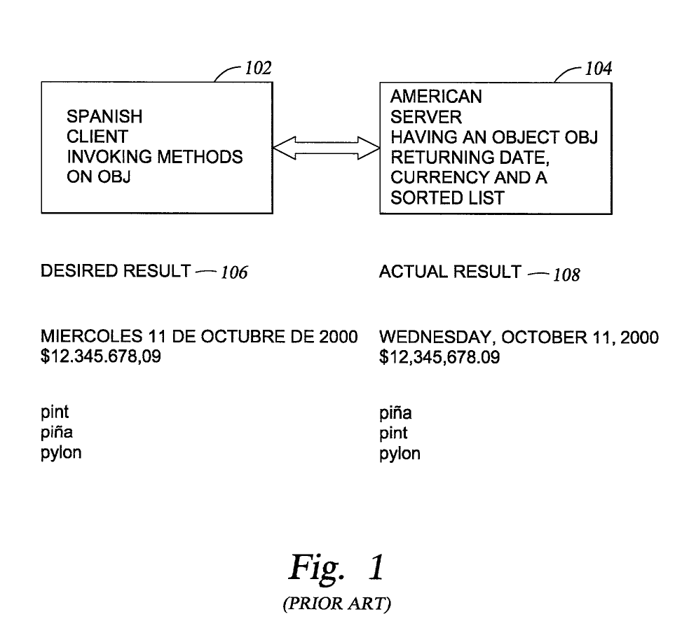

### DETAILED DESCRIPTION OF THE PREFERRED EMBODIMENT

The present embodiments provide an article of manufacture, a method and a system for processing client requests in a distributed computer network using the user's specified locale conventions. In one embodiment, a client sends a business method request along with associated internationalization context to a remote server. The internationalization context comprises client locale specific information comprising preferred location and time zone information used in processing the associated business method request. The internationalization context is composed according to an internationalization context management policy. The application server extracts the internationalization context associated with and obtains the internationalization context management policy assigned to the incoming business method request. The server-side application then processes the associated business method request according to the internationalization context and the internationalization context management policy. In another embodiment, the server forwards the client's business method request to a second server and propagates the internationalization context to the second server.

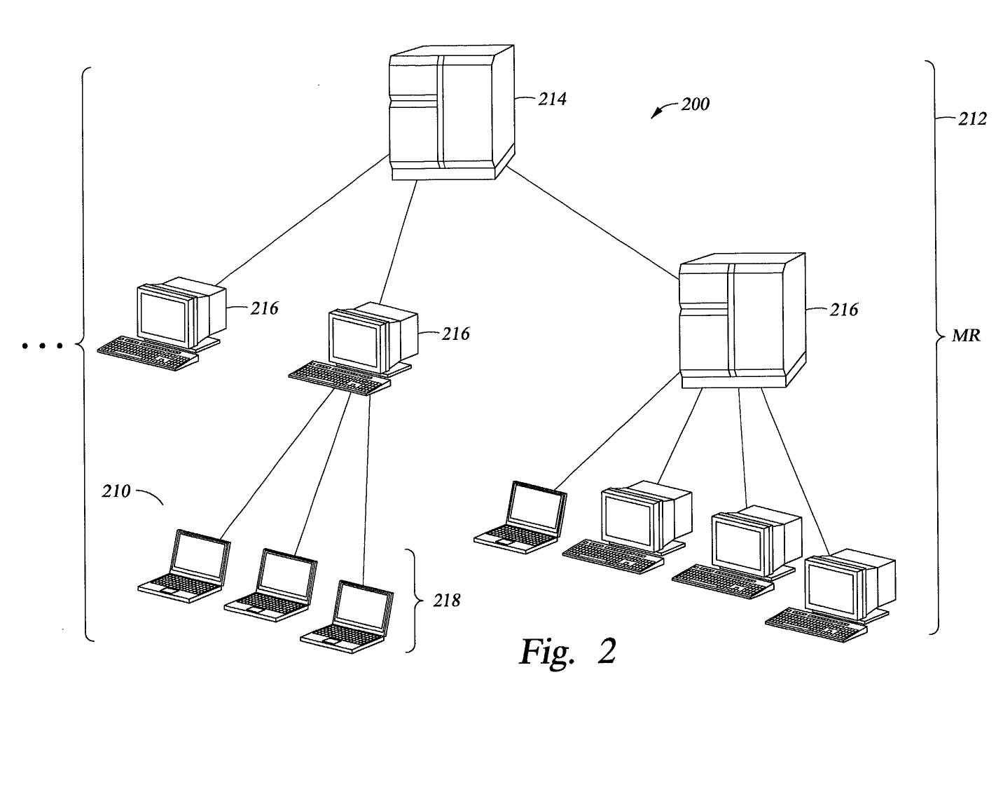

FIG. 2 illustrates one embodiment of a large distributed computer environment 200, also referred to as the managed environment, comprising up to thousands of “nodes”. The nodes will typically be geographically dispersed and the overall environment is “managed” in a distributed manner. Preferably, the managed environment (ME) 200 is logically broken down into a series of loosely-connected managed regions (MR) 212, each with its own management server 214 for managing local resources with the MR. The network typically will include other servers (not shown) for carrying out other distributed network functions. These include name servers, security servers, file servers, thread servers and the like. Multiple servers 214 coordinate activities across the enterprise and permit remote management and operation. Each server 214 serves a number of gateway machines 216, each of which in turn support a plurality of endpoint machines 218. The server 214 coordinates all activity within the MR using terminal node manager 210.

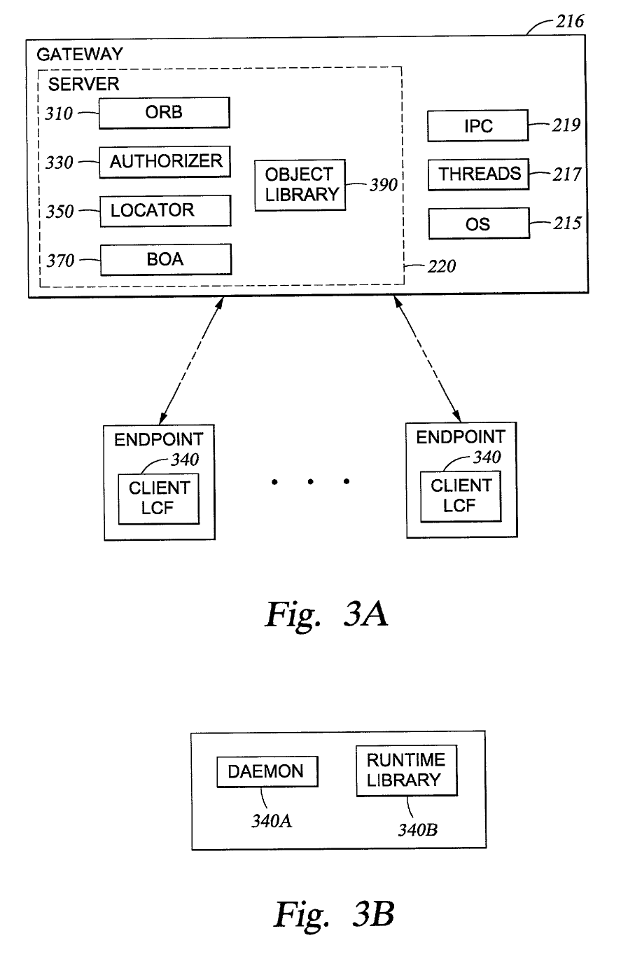

FIG. 3A illustrates each gateway machine 216 that runs a server component 320 of a system management framework. The server component 320 is a multi-threaded runtime process that comprises several components: an object request broker (ORB) 310, an authorization service 330, object location service 350 and basic object adapter (BOA) 370. Server component 320 also includes an object library 390. Preferably, the ORB 310 runs continuously, separate from the operating system and it communicates with both server and client processes through separate stubs and skeletons via an inter-process communication (IPC) facility 219. In particular, a secure remote procedure call (PRC) is used to invoke operations on remote objects. Gateway machine 216 also includes a thread mechanism 217. The thread mechanism 217 is known in the art and assigns a thread identifier to each request made by a user at a gateway machine 216. The thread identifier may be any alphanumeric representation. The thread identifier is associated with the request so that the server can track the request and send a response to the proper gateway machine 216.

The system management framework includes a client component 340 supported on each of the endpoint machines 218. The client component 340 is a low cost, low maintenance application suite that is preferably “data-less” in the sense that system management data is not cached or stored there in a persistent manner. Implementation of the management framework in this “client-server” manner has significant advantages over the prior art, and it facilitates the connectivity of personal computers into the managed environment. Using an object-orientated approach, the system management framework facilitates execution of system management tasks required to manage the resources in the MR.

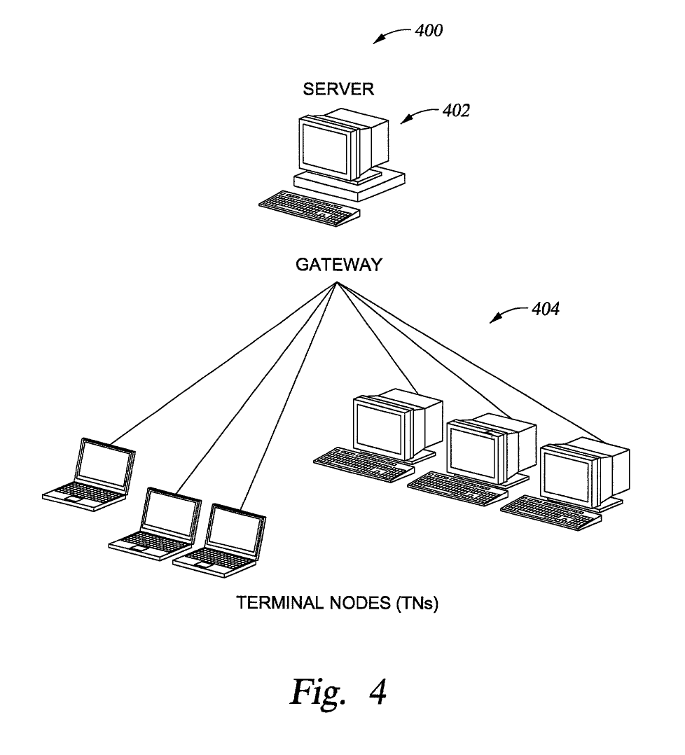

In a large computer enterprise such as illustrated in FIG. 2, preferably there is one server per MR with some number of gateways. For a workgroup-size installation 400 (a local area network, for example) such as illustrated in FIG. 4, a single server class machine 402 may be used as the server and gateway to a plurality of terminal nodes 404. References herein to a distinct server and one or more gateway(s) should thus not be taken by way of limitation as these elements may be combined into a single platform. For intermediate size installations, the MR grows with additional gateways then being used to balance the load of the endpoints.

The server 214 is the top-level authority over all gateway and endpoints. The server maintains an endpoint list, which keeps track of every endpoint in a managed region. This list preferably contains all information necessary to uniquely identify and manage endpoints including, without limitation, such information as name, location, and machine type. The server also maintains the mapping between endpoints and gateways, and this mapping is preferably dynamic.

Illustratively, there are one or more gateways per managed region. Preferably, a gateway is a fully managed node that has been configured to operate as a gateway. Initially, a gateway “knows” nothing about endpoints. As endpoints log-in, the gateway builds an endpoint list for its endpoints. The gateway's duties preferably include listening for endpoint login requests, listening for endpoint update requests, and acting as a gateway for method invocations on endpoints.

The endpoint is a machine running the system management framework client component, which is referred to herein as a management agent. The management agent has two main parts, the daemon 340a and application runtime library 340b, as illustrated in FIG. 3B. The daemon 340a is responsible for endpoint login and for spawning application endpoint executables. Once an executable is spawned, the daemon 340a has no further interaction with it. Each executable is linked with the application runtime library 340b, which handles all further communication with the gateway.

Preferably, the server and each of the gateways are a computer or “machine”. As an illustration, each computer may be a RISC (reduced instruction set computer) System/6000® running AIX (Advanced Interactive Executive) operating system. Suitable alternative machines include an IBM-compatible PC running Novell UnixWare or an AT&T 3000 series machine running AT&T UNIX. Other machines and/or operating systems may be used for the gateway and server machines.

Each endpoint is also a computer. In one embodiment, the endpoints are personal computers such as desktop machines, laptops, hand-held personal digital assistants (PDA) or the like. The endpoints need not be high powered or complex machines or workstations. Illustratively, one or more of the endpoints may be a notebook computer, for example, the IBM ThinkPad® machine, some other Intel x86 or Pentium®-based computer running the Windows operating system or IBM-compatible machines running under the OS/2® operating system. An endpoint computer preferably includes an Internet client navigation program such as Netscape Navigator or Microsoft Internet Explorer. An endpoint computer thus may be connected to a gateway via the Internet, an Intranet or some other computer network. The connection to a gateway may be wireless using radio frequency energy, visible or non-visible light emissions or through a hard-wire link.

It should be understood that the network environment of FIG. 2 is merely illustrative. The particular arrangement and devices of the network environment are not so limited. More generally, any distributed system may used to advantage.

Moreover, while the embodiments have and hereinafter will be described in the context of fully functioning computers and computer systems, those skilled in the art will appreciate that the various embodiments of the invention are capable of being distributed as a program product in a variety of forms, and that embodiments of the invention apply equally regardless of the particular type of signal bearing media used to actually carry out the distribution. Examples of signal bearing media include, but are not limited to, recordable type media such as volatile and nonvolatile memory devices, floppy and other removable disks, hard disk drives, optical disks (e.g., CD-ROMs, DVDs, etc.), and transmission type media such as digital and analog communication links. Transmission type media include information conveyed to a computer by a communications medium, such as through a computer or telephone network, and includes wireless communications. The latter embodiment specifically includes information downloaded from the Internet and other networks. Such signal-bearing media, when carrying computer-readable instructions that direct the functions of the present invention, represent embodiments of the present invention.

In one embodiment, a computer system operative in the managed environment provides declarative policies for managing internationalization context comprising locale and time zone information. Illustratively, the management policies may be specified in XML (Extensive Markup Language) that is read and parsed by a J2EE or CORBA deployment of the internationalization context. XML is a specification designed for Internet Web documents that allows the definition, transmission, validation, and interpretation of data between application components.

As an illustration, all J2EE and CORBA application components are hosted in containers. A container is the architected element within an application server that manages the lifecycle of and provides the runtime environment for application components. Containers for J2EE (as published by Sun Microsystems) and CORBA (as published by the Object Management Group) manages the lifecycle and provides the runtime environment for application components.

With each business method dispatch, a client computer propagates to a server caller internationalization context (CIC) comprising client preferred locale and time zone information of the client application component. The computer servicing the request (a server computer for example) will extract the CIC associated with the incoming request. Using XML, the computer will then determine the requested business method implementation and the associated internationalization context management policy from the container hosting the application component. It may further obtain associated internationalization context elements from the container, also specified using XML, if required by the management policy. The computer will then compose an invocation internationalization context (IIC) according to the management policy by using internationalization elements derived by the caller, the local process, or the container. The IIC is the locale and time zone information under which the requested business method is processed. The computer associates the CIC and the IIC to the thread that will execute the business method request and then dispatches the request. Once dispatched, the CIC and IIC are obtained so that the method implementation can use them to localize processing of the request.

As an illustration, invocation internationalization context policies may be application-managed internationalization, bean managed internationalization and container managed internationalization. These policies are discussed in detail below.

Application Managed Internationalization (AMI)

Illustratively, an application can access locale and time zone information of the invocation internationalization context using the appropriate application-programming interface (API). The Application Managed Internationalization policy directs the container to transfer control for managing invocation internationalization context to the application developer. For J2EE and CORBA Java application clients, this is the only applicable internationalization context management policy.

The AMI policy may be applied to application components deployable within the J2EE Web and Client containers. A Web container is the architected element of a J2EE-compliant application server that manages the lifecycle of and provides the runtime environment for Web-based Java application components. This includes Java Servlets and Java Server Pages (JSP). A Client container manages the lifecycle of and provides the runtime environment for J2EE Java application clients. The J2EE Java application clients are essentially non-managed and require minor support from their container. CORBA application servant objects also may operate under the AMI policy. XML descriptors are used to convey the AMI context management policy to the container when deploying such application components. When servicing a Servlet or JSP business method, the Web container will supply the AMI policy descriptor. When servicing a client request, the Client container assumes the AMI policy. In the event that a business method running under the AMI policy issues a subsequent business method request and did not set an invocation internationalization context element via the API, the servicing computer will propagate the element derived from the local process along with the request.

Bean Managed Internationalization (BMI)

Illustratively, BMI is applicable only to Enterprise JavaBeans known in the art. In one embodiment of the present application, the policies of BMI are identical to that of AMI described above. An Enterprise JavaBean is a distributed object model for Java server-side application components that are deployed within and exercised by J2EE-compliant application servers. There are three main types of Enterprise JavaBeans. Those are session beans, entity beans, and message-driven beans. Enterprise JavaBean implementations will primarily provide business logic and database access functions within a J2EE application. The BMI context management policy may be applied to all types of Enterprise JavaBeans.

At deployment, an application's Enterprise JavaBeans are loaded into an EJB Container. The EJB container is the architected element of a J2EE-compliant application server that manages the lifecycle of and provides the runtime environment for an Enterprise JavaBeans. XML descriptors are used to specify the BMI context management policy to the container. When servicing an Enterprise JavaBean business method, the EJB container will provide the associated BMI policy descriptor. In the event that an EJB business method implementation invokes another business method and did not set an invocation internationalization context element via the API, the servicing computer will propagate the element derived from the local process along with the request.

Container Managed Internationalization (CMI)

As an illustration, CMI is the preferred management policy for server-side components. The various application component containers assume the responsibility of managing the invocation internationalization context. For a component (or business method) deployed as CMI, an application developer does not have the ability to set any element of the invocation internationalization context. Illustratively, CMI policy can be RunAsCaller, RunAsServer or RunAsSpecified.

Under the RunAsCaller policy, a business method will get executed under the internationalization context of the caller (client). The invocation internationalization context comprises the locale and time zone information associated with the inbound call.

Under the RunAsServer policy, a business method will get executed under the internationalization context of the server process. The invocation internationalization context comprises the locale and time zone information of the server process.

Under the RunAsSpecified policy, the locale and time zone information is specified in the XML deployment descriptor of the application component. A business method will get executed under the locale and time zone specified in the deployment descriptor. In the event that a business method implementation invokes another business method, and an invocation internationalization context element was not specified via the XML descriptor, the servicing computer will propagate the element derived from the local process along with the request.

Deployment Descriptors

Illustratively, deployment descriptors, illustratively written in XML, provide the mechanism for declaratively managing internationalization context within applications at the time of deployment. Although the XML examples that follow describe the management of internationalization context within J2EE application components, CORBA application components may also be deployed using similar XML schemes. Furthermore, while the examples utilize Java formalisms, other programming methods are equally applicable.

A Servlet or JSP can be deployed in a J2EE Web application with an ‘internationalization-type’ element. The internationalization-type element specifies a server-side Web component's internationalization type. As an illustration, the internationalization type element may be either “Application” (<internationalization type>Application</internationalization type>) or “Container” (<internationalization type>Container</internationalization type>). In one embodiment, the default internationalization type element is “Container”.

Illustratively, as used in container managed internationalization, an EJB can be deployed in a J2EE application in a similar manner to that of a Servlet or JSP described above. For Enterprise JavaBeans, the internationalization-type element can be either “Bean” or “Container”. For container managed internationalization, there is an internationalization-attribute element specifying the value of the internationalization context that is associated to an invoked business method. Illustratively, the internationalization-attribute element may be RunAsCaller, RunAsServer or RunAsSpecified. The default is RunAsCaller for session and entity beans. For message-driven beans, the default is RunAsServer

Illustratively, as used in the RunAsSpecified container internationalization, the locale element specifies the locale under which a server-side web component or the business method of an Enterprise JavaBean will execute. As an illustration, the first element may be a one or two letter ISO-639 language code. The second element may be a two-letter ISO-3166 country code. The third element, if present, may indicate a variance where for example, a country code can be specified to be empty. The presence of a variant element mandates the presence of a non-empty country element. The time zone element specifies the time zone under which a server-side web component or the business method of an EJB will execute. The value of a time zone element is any valid time zone identification contained in the Java Software Development Kit (SDK). The SDK, developed by Sun Microsystems, is the software development kit for developing Java applications.

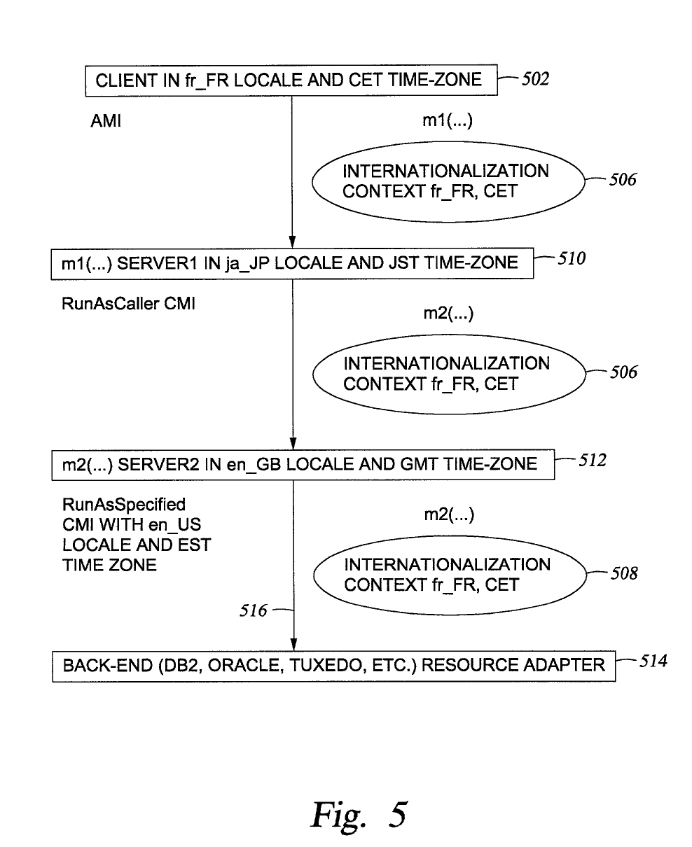

FIG. 5 shows a network environment illustrating the propagation of the internationalization context 506 from a client request to a remote server and then to another server and a back-end data store. The client 502 is located in a French locale and CET (Central European Time) time zone. The invocation internationalization context 506, comprising the client's locale and time-zone information, is transmitted separately from the called method function m1( . . . ). Upon receiving the client request at the server 510, deployed as RunAsCaller CMI, in the Japan locale and JST (Japanese standard time) time zone, the server 510 will extract the client's internationalization context and, according to the context management policy, provide the client's internationalization context to request. In this example, it is necessary to further process the client request at another remote server 512, deployed as RunAsSpecified, located in the Great Britain locale and GMT (Greenwich Mean Time) time zone. Since the deployment of server 512 is RunAsSpecified, the server 512 creates an invocation internationalization context 508 comprising the deployment specified English locale and EST (eastern standard time) time zone when further servicing the request at the back-end data store 514 through a J2EE connector.

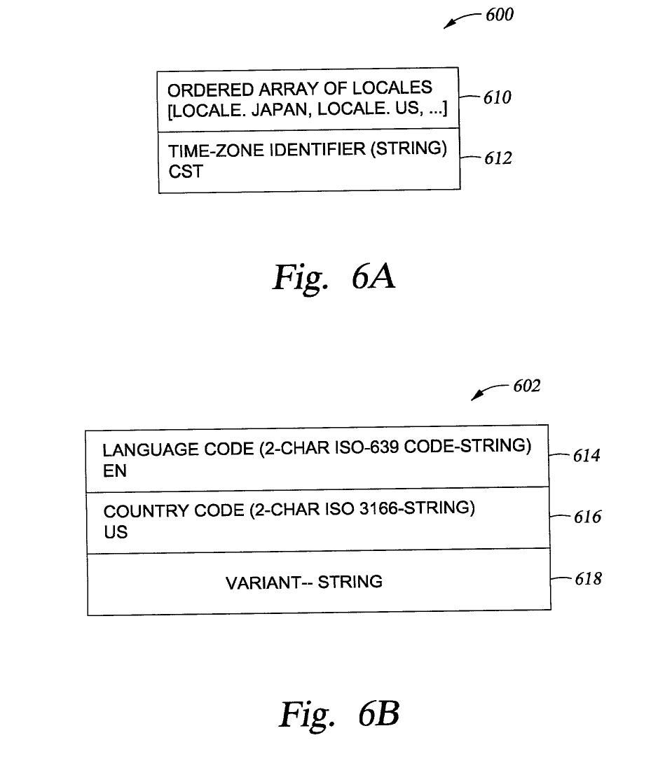

FIG. 6A illustrates one embodiment of the internationalization context data structure 600. The internationalization context data structure 600 comprises an ordered array of locales 610 and a time-zone identifier 612. The ordered array of locales is a sequential list of preferred locales for processing the client request. Illustratively, the most preferred locale will be selected for the client locale. FIG. 6B further illustrates the data structure for a locale entry 602 contained in the ordered array of locales 610. Illustratively, the locale entry 602 comprises a language code 614, a country code 616 and a variant-string 618. The language code 614 may be a two character ISO-639 standard identifier. The country code 616 may be a two character ISO-3166 standard identifier. The variant-string 618 may contain further locale sensitive information such as currency formatting data or specifying a region within a country, for example. One of ordinary skill will appreciate that the foregoing illustrated example of the internationalization context data structure 600 is merely representative. It should be appreciated that other logical combinations of locale specific information may be contained in the internationalization context data structure 600. In particular, the internationalization context 610 and the time zone identifier 612 may be spread over a plurality of data structures and cross referenced by pointers.

In one embodiment, the internationalization context 600 may be implemented as a service context, processed by the ORB 210 (see FIG. 2) within CORBA (common object request broker architecture). CORBA is an architecture that enables application components, called objects, to communicate with one another regardless of what programming language they were written in or what operating system they are running on. There are several implementations of CORBA, the most widely used being IBM's SOM (system object model) and DSOM (distributed system object model) architectures. SOM is a programming architecture developed by IBM that allows binary code to be shared by different applications. DSOM is a version of SOM that supports sharing binary objects across networks.

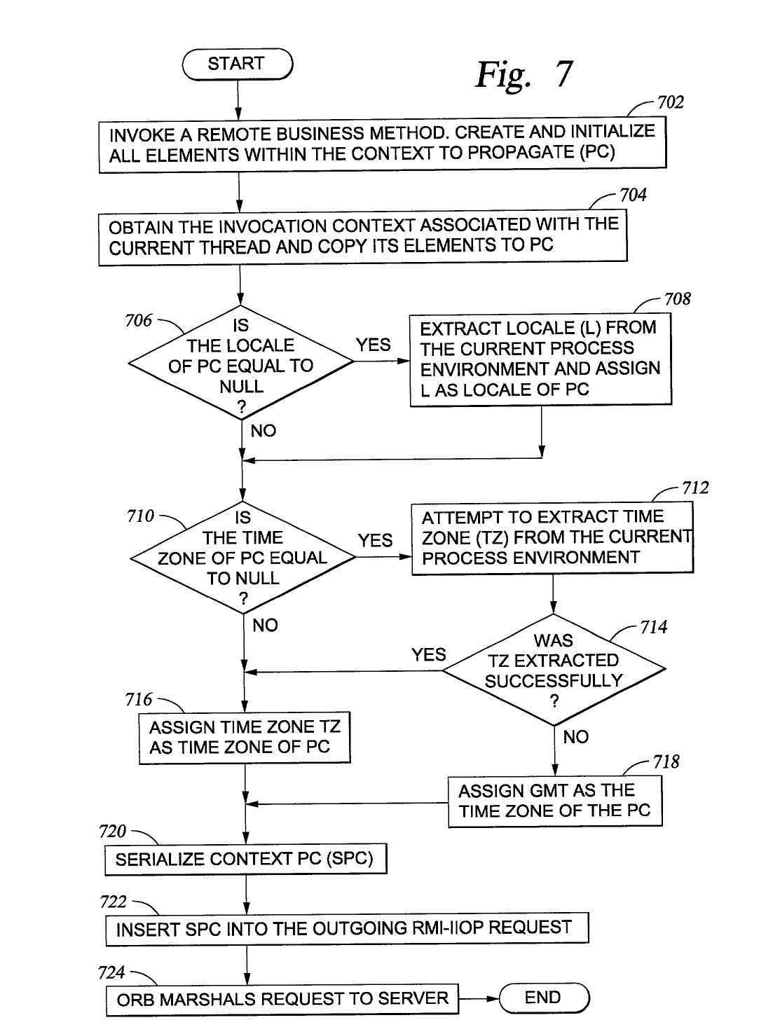

FIG. 7 illustrates a flowchart implementing management of the internationalization context at a client side. The routine begins at step 702 whenever the client application component invokes a remote business method. In preparation for the population of locale and time zone elements within the context to be propagated (PC), all element areas are created and initialized.

At step 704, the invocation context associated with the current thread is obtained and its elements are copied into the PC. Illustratively, the invocation context comprises locale and time zone information and context management policies. At step 706, the routine queries if the locale information in the internationalization context is set to null data. If so, the routine places the locale information from the default setting of the client computer and places it in the internationalization context at step 708 and proceeds to step 710. If the internationalization context is not set to null data, the routine, at step 710, queries if the time zone information is set to null data. If so, the routine attempts to extract the time zone information from the current process environment at step 712 and proceeds to step 714. At step 714, the routine queries if the time zone information was successfully extracted from the current process environment. If so, the routine proceeds to step 716 where the time zone is set to the extracted time zone. If not, the routine proceeds to step 718 where the time zone is set to Greenwich Mean Time (GMT). The routine then proceeds to step 720.

At step 720, the information contained in the internationalization context is converted into serialized form and then placed with the outgoing RMI-IIOP request at step 722. The routine then proceeds to step 724 where the request is marshaled to the server.

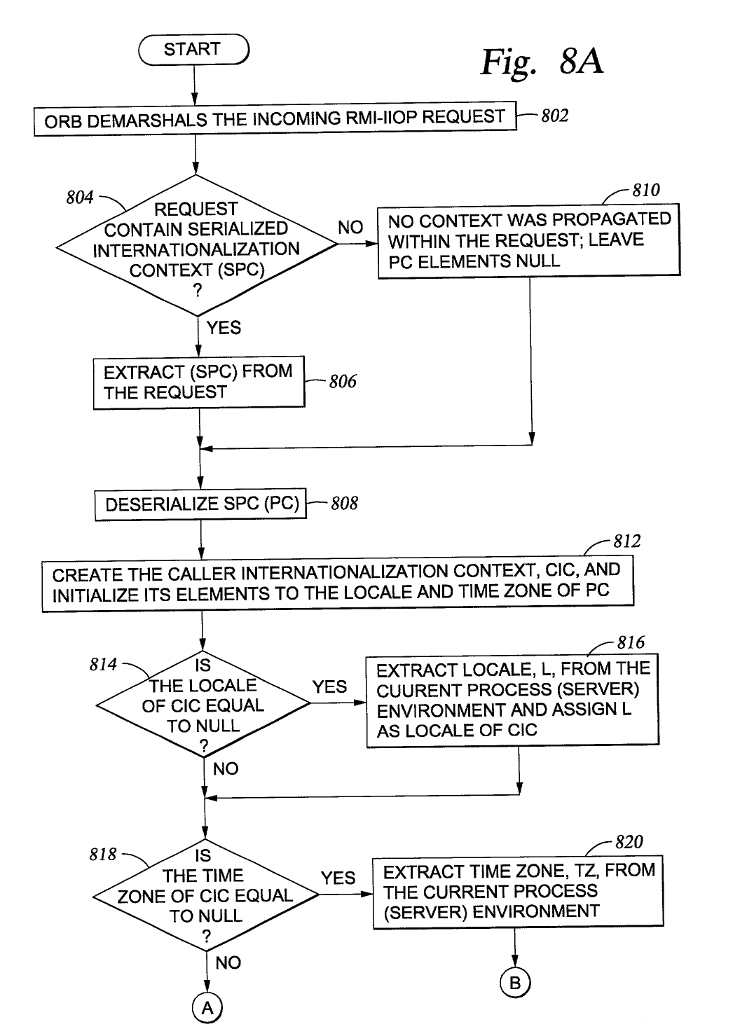

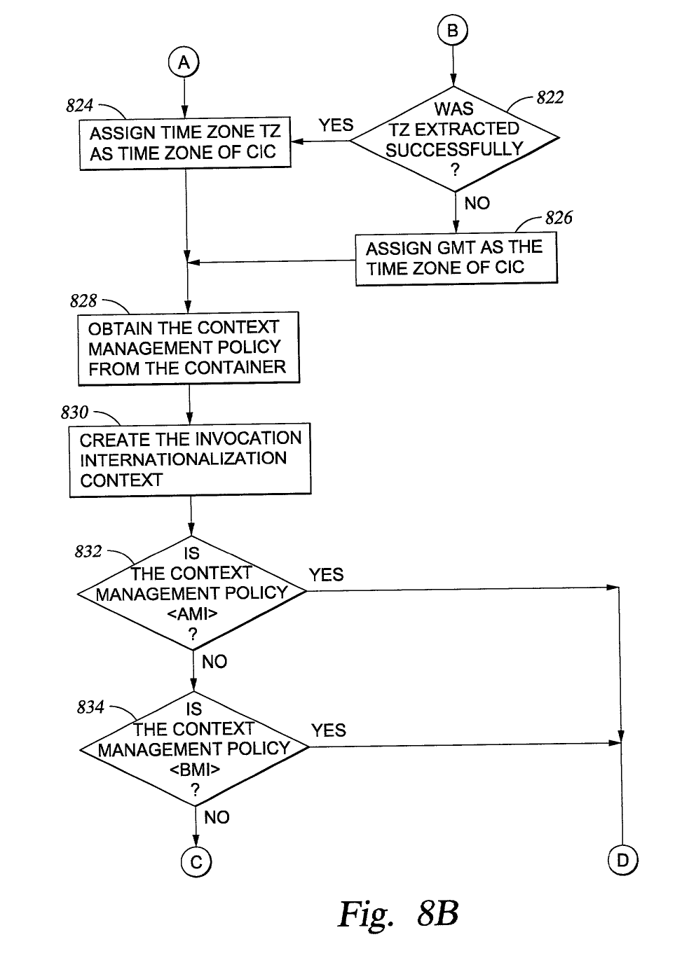

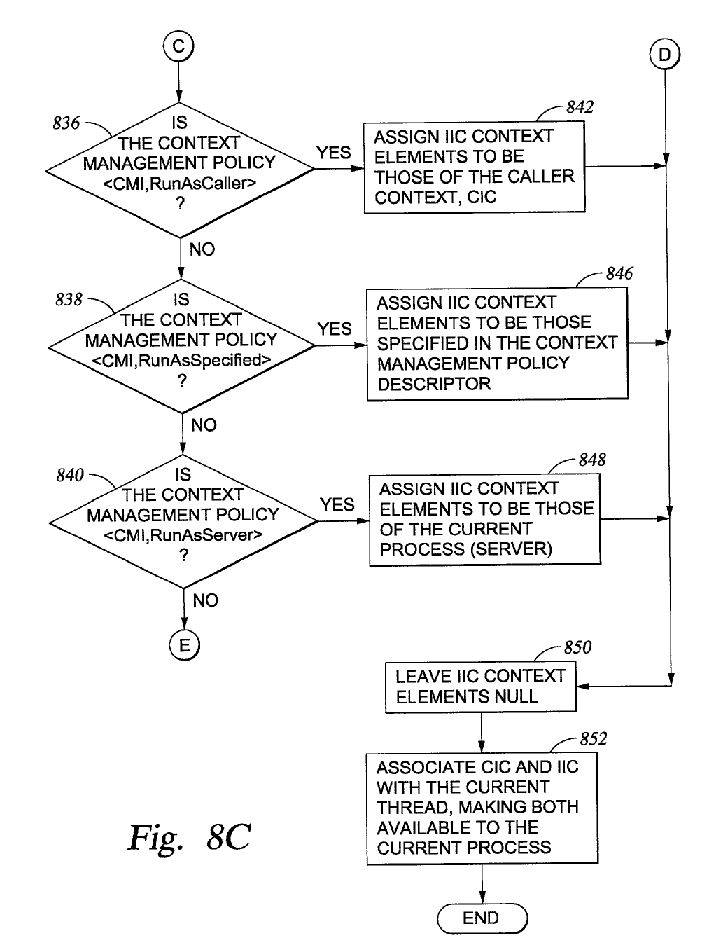

FIG. 8 illustrates a flowchart for computing the internationalization context 600 propagated to a server computer. The routine begins at step 802 where the ORB 310 de-marshals the incoming RMI-IIOP request. At step 804, the routine queries if the request contains serialized internationalization context. If so, the propagated internationalization context (PC) is extracted from the request at step 806. If the request does not contain the internationalization context, the routine, at step 810, sets the locale and time zone information is set to null. The routine then proceeds to step 808 where the serialized internationalization context is placed in de-serialized form.

At step 812, a caller internationalization context (CIC) is created and its elements are initialized to the locale and time zone of the propagated context (PC). At step 814, the routine queries if the locale information in the caller internationalization context is set to null. If so, the routine proceeds to step 816 where the default locale of the server is extracted and assigned as the locale for processing the request. If the locale information is not set to null, the routine, at step 818, queries if the time zone information of the CIC is set to null. If so, the routine, at step 820, attempts to extract the time zone information from the current process environment. At step 822, the routine queries if the time zone information was successfully extracted. If not, the routine, at step 826, assigns GMT time as the time zone for the internationalization context. If so, the successfully extracted time zone information is assigned as the time zone of the internationalization context at step 824.

At step 828, the routine obtains the context management policy from the container. At step 832, the routine creates an invocation internationalization context (IIC) with its elements initialized to null. At step 832, the routine queries if the management policy is AMI. At step 834, the routine queries if the management policy is BMI. If the management policy is either AMI or BMI, the routine proceeds to step 850 where the IIC elements are left at null. If the management policy is neither AMI nor BMI, the routine proceeds to step 836 where the routine queries if the management policy is CMI RunAsCaller. If so, the routine assigns the IIC elements to be those of the CIC. The routine then proceeds to step 852 where the CIC and IIC are associated with the current thread making both available to the current process. If the management policy is not CMI RunAsCaller, the routine queries, at step 838 if the management policy is CMI RunAsSpecified. If so, the IIC elements are assigned to be those specified in the context management policy descriptor at step 846. The routine then proceeds to step 852. If not, the method queries if the management policy is CMI RunAsServer. If so, the IIC elements as assigned to be those of the current server process. The routine then proceeds to step 852. If not, the routine proceeds to step 850.

Accordingly, the present embodiments provide for transmitting and managing internationalization information. Receiving machines (e.g., servers) are configured (e.g., with Application programming interfaces (APIs)) to provide the internationalization information to an application. The application may then use the internationalization information in preparing a response to a client or in order to perform processing in general. For example, the internationalization information may be used to format a response according user preferences. In another embodiment, the internationalization information may provide rules or conditions for calculations (e.g., preparing tax returns, e-Commerce transactions, etc.). In this manner, the present embodiments ensure meaningful network transactions that are sensitive to international diversity.

While the foregoing is directed to embodiments of the present invention, other and further embodiments of the invention may be devised without departing from the basic scope thereof, and the scope thereof is determined by the claims that follow.

What is claimed is:

1. A system in a distributed computing environment having a plurality of nodes located across geographically dispersed boundaries, comprising:
a server configured with an internationalization application programming interface configured to extract an internationalization context provided by a client device and retrieve an internationalization context management policy; and
a resource manager configured to receive the internationalization context and internationalization context management policy extracted by the server and process a request received from the client device using the internationalization context that is configured by the internationalization context management policy.

2. The system of claim 1, wherein the resource manager is a database management system.

3. The system of claim 1, wherein the resource manager comprises an application which is configured to use the internationalization context according to the internationalization context management policy to perform calculations and return a result formatted according to a specification of the internationalization context.

4. The system of claim 1, wherein the internationalization context contains at least one of a country identification, a language identification and a time zone identifier.

5. The system of claim 1, wherein the internationalization context is transmitted by the server to at least one of the plurality of nodes in the distributed computing environment.

6. The system of claim 1, wherein the internationalization context comprises locale information and a time zone identifier.

7. The system of claim 6, wherein the locale information comprises at least one of a country identifier, a language identifier and a currency identifier.

8. A method of processing requests in a distributed computing environment having clients and a plurality of servers located across geographically dispersed boundaries, comprising:
receiving a first request from a client at a server;
receiving a second request from the client at the server, wherein the second request comprises an internationalization context for processing the first request;
extracting the internationalization context from the second request;
retrieving an internationalization context management policy; and
processing the first request at the server using the internationalization context that is configured by the internationalization context management policy.

9. The method of claim 8, wherein processing the first request comprises providing the first request and internationalization context to an application to perform calculations using the internationalization context and return a result formatted according to the internationalization context.

10. The method of claim 8, wherein the context management policy assigns context elements to be those of the client context.

11. The method of claim 8, wherein the context management policy assigns context elements to be those of a predefined descriptor.

12. The method of claim 8, wherein the context management policy assigns context elements to be those of the server process.

13. The method of claim 8, further comprising sending the internationalization context from the server to at least one of the plurality of servers in the distributed computing environment.

14. The method of claim 8, wherein the internationalization context contains at least one of a country identifier, a language identifier and a time zone identifier.

15. The method of 8, wherein the internationalization context contains at least a locale specification and a time zone identifier.

16. The method of claim 15, wherein the locale specification comprises at least one of a country identifier, a language identifier and a currency identifier.

17. The method of claim 8, further comprising processing the first request according to a country identifier of the server if the internationalization context does not contain a country identifier.

18. The method of claim 8, further comprising processing the first request according to a universal time zone identifier if the internationalization context does not contain a time zone identifier of the client.

19. The method of claim 8, further comprising processing the first request according to a time zone identifier of the server if the internationalization context does not contain a time zone identifier.

20. A method of processing requests in a distributed computing environment comprising a client computer and a plurality of server computers, comprising:
receiving, at one of the plurality of server computers, an internationalization context from the client computer , wherein the internationalization context contains at least a locale specification and a time zone identifier;
retrieving an internationalization context management policy; and
processing a request from the client computer according to the internationalization context that is configured by the internationalization context management policy.

21. The method of claim 20, wherein the context management policy assigns context elements to be those of the client context.

22. The method of claim 20, wherein the context management policy assigns context elements to be those of a predefined descriptor.

23. The method of claim 20, wherein the context management policy assigns context elements to be those of the server process.

24. The method of claim 20, wherein the internationalization context contains at least one of a country identifier, a language identifier and a time zone identifier.

25. The method of claim 20, wherein the client and the plurality of servers are located across geographically dispersed boundaries.

26. The method of claim 20, wherein the locale specification comprises at least one of a country identifier, a language identifier and a currency identifier.

27. A signal bearing medium, comprising a program which, when executed, performs an operation, comprising:
receiving a request from a client computer, wherein the request contains internationalization context;
extracting the internationalization context from the request;
retrieving an internationalization context management policy; and
providing the internationalization context to an application in order to configure the application to process a request from the client computer according to the internationalization context that is configured by the internationalization context management policy.

28. The signal bearing medium of claim 27, wherein the context management policy assigns context elements to be those of the client context.

29. The signal bearing medium of claim 27, wherein the context management policy assigns context elements to be those of a predefined descriptor.

30. The signal bearing medium of claim 27, wherein the context management policy assigns context elements to be those of the server process

31. The signal bearing medium of claim 27, wherein the internationalization context contains at least one of a country identifier, a language identifier and a time zone identifier.

32. The signal bearing medium of claim 27, wherein the internationalization context contains at least a locale specification and a time zone identifier.

33. The signal bearing medium of claim 32, wherein the locale specification comprises at least one of a country identifier, a language identifier and a currency identifier.
